(19) United States
(12) Patent Application Publication
(10) Pub. No.: US 2024/0381849 A1
(43) Pub. Date: Nov. 21, 2024

(54) SMART POULTRY COOP WITH LOCAL SERVICES MARKETPLACE AND ONLINE COMMUNITY

(71) Applicant: Coop, Inc., Austin, TX (US)

(72) Inventors: Adam Forsythe, Volente, TX (US); Jordan Barnes, Dallas, TX (US); Paul Ilia, Dallas, TX (US); Ryan Romanchuk, Volente, TX (US); Zhou Li, Shenzhen (CN); Oleksandr Davydenko, Richmond Hill (CA)

(21) Appl. No.: 18/667,124

(22) Filed: May 17, 2024

Related U.S. Application Data
(60) Provisional application No. 63/467,876, filed on May 19, 2023.

(51) Int. Cl. A01K 31/02; A01K 29/00; A01K 31/16; A01K 31/18; E05F 15/77; G06Q 30/0601

(52) U.S. Cl. CPC A01K 31/02; A01K 29/005; A01K 31/165; A01K 31/18; E05F 15/77; G06Q 30/0601

(57) ABSTRACT

A coop system, methods and services related thereto are provided. In particular, the coop system and features related thereto prevents predators from entering a coop, simplifies maintenance of the coop, and enables a poultry keeper to order services for overseeing chickens and cleaning coop environments. The coops described herein are automated, eliminate the use of wood in its construction, comprise pest-resistant materials and improve ventilation mechanisms. The coops further include cameras with smart predator detections and event recording capabilities. A mobile application is also provided which allows a poultry keeper to remotely access the coop's smart technology, thereby allowing the poultry keeper to better monitor, maintain, and safekeep coops.

### CROSS-REFERENCE TO RELATED APPLICATIONS

The present application claims priority to U.S. Application Ser. No. 63/467,876, filed May 19, 2023, which is hereby expressly incorporated by reference in its entirety for all purposes.

### FIELD

The present subject matter broadly relates to coops. More particularly, the present subject matter relates to poultry coops, and methods and services related thereto.

### BACKGROUND

Existing poultry coops available in the market today are typically made of off-the-shelf, low-grade lumber and steel, and designed just as they were hundreds of years ago. This lack of innovation has created at least five core problems for these coops, as will be described below.

First, due to the organic material construction and constant exposure to climate/weather, coops quickly lose their aesthetic appeal and ultimately break down after two to three years of use. As such, traditional poultry coops suffer from weak construction and short life expectancy.

Second, due to their organic material construction, poor ventilation, and constant exposure to poultry food and/or waste, coops are malodorous and easy-to-invade hosts for all ranges of molds, red mites, and rats. In this regard, traditional coops fail to properly defend against fungi, odor, pests, rodents, and the like.

Further, without technology, for example, surveillance cameras, automated doors and/or remote-management applications, to name a few, coops must be checked in-person daily, creating a massive time constraint. Thus, another drawback of traditional coops is the lack of automation or remote management that can be associated therewith.

Moreover, cleaning coops can be labor-intensive and impractical at times, yet is imperative for raising healthy poultry. Unfortunately, it is not uncommon for there to be confusion and inconsistencies associated with cleaning procedures and/or standards, thereby leading to unsanitary or unkept conditions.

Once coops are set up and in use, it can be difficult to find an ecosystem of support from others in the community who also have poultry and could assist in coop maintenance, temporary flock care, and/or general troubleshooting. The inability to connect with other local poultry farms for educational purposes or support is yet another disadvantage associated with conventional coops.

Addressing the aforementioned issues is crucial to improving the overall poultry rearing experience and increasing the proliferation of poultry coops in places, such as backyards.

Most interested individuals are hesitant to raise backyard chickens because the existing solutions either do not meet their aesthetic aspirations, exceed their time and labor capabilities, and/or lack deeper, hands-on learning and support. Some companies have attempted to solve a few of the problems inherent to backyard poultry coops with newer material construction from metal and plastic, but these alternatives still fall short in actually innovating the experience for the user. There have still been no successful attempts at providing solutions for either services or community, which continues to restrict the pool of potential backyard poultry keepers.

### SUMMARY

Thus, improved coops, and methods and services related thereto are needed.

The present subject matters addresses the aforementioned disadvantages by providing an improved coop, and methods and services related thereto.

The coop embodiments described herein are smart poultry coops with updated designs, construction, capabilities, and support. Specifically, the coop embodiments described herein provide a shelter which eliminates the use of wood in its construction, is made of easy-to-clean, pest-resistant materials, and comes with custom-made compostable and recyclable litter trays that cover the shelter floor and make bedding and waste cleaning easy and convenient. In some embodiments, the coop comprises intentionally designed ventilation systems and features, and a double-walled panel design which can include optional foam insulation for protection against extreme heat and cold.

Additionally, in some embodiments, the coop is equipped with an automatic, battery-powered door(s) that opens at and closes at any desired time via a sensor, such as an integrated light sensor. For example, the door(s) can open at sunrise and close at sunset via the integrated light sensor. The door(s) can communicate with a remote device via a communication path using a wired or wireless technique so as to allow a user to control the opening and/or closing of the door through the remote device at a remote location. In some embodiments, the user can control the opening and/or closing of the door through a mobile application (also herein referred to as a “mobile app,” “app” or “Coop app”) and/or web portal. The door(s) are configured such that they can be programmed so as to use GPS coordinates for improved tracking of different times of a day, e.g., at sunrise and sunset. In some embodiments, the coop further comprises dual, wireless video surveillance cameras with smart predator detection, event recording, mobile notifications, as well as a built-in flashlight and siren alarm to repel predators.

According to some embodiments, the coop's smart technology is entirely remotely accessible through the mobile app and/or web portal, giving the ability to monitor a coop's flock and operate coop technology 24/7 from anywhere in the world. Furthermore, in some exemplar embodiments, the coop shelter is affixed to a heavy-duty metal run that safeguards against both land and aerial predators, while the coop's enhanced elevation from the ground and lockable doors provide added security.

Furthermore, in some embodiments, the mobile app can provide individuals, such as, coop owners, access to a local marketplace to connect with other poultry keepers nearby who are providing coop cleaning and flock watching services, simplifying backyard poultry care and maintenance. The mobile app can also provide individuals access to a local marketplace which can allow trading. For example, the local marketplace in the mobile app can allow individuals, such as backyard farmers, to trade produced eggs and/or baby chicks with other third parties, such as, neighbors or other farmers at a remote location.

Advantageously, in the embodiments described herein, an improved design for coops and services associated therewith can attract individuals who previously did not consider raising chickens. As a positive consequence, the increase in the number of backyard coops decentralizes egg production and supply chains, offering consumers eggs with up to 20 times higher nutritional value while reducing food scraps that can be fed to chickens. This approach can address the issue of nearly 40% of food waste generated by individuals, transforming it into healthier, more nutrient dense eggs that can ultimately be consumed at home and bought and sold locally through the mobile app's and/or web portal marketplace.

Other features and advantages of the present subject matter will be appreciated by those skilled in the art upon reading the detailed description which follows with reference to the drawings.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be depicted schematically rather than literally or precisely.

FIG. 1 is a perspective side view depicting an exemplar embodiment of a coop installed on a metal base, wherein the coop includes an attached run assembly.

FIG. 2 is a top view of the coop and run assembly illustrated in FIG. 1.

FIG. 3 is a bottom view of the coop and run assembly illustrated in FIG. 1.

FIG. 4 is a perspective side view of the coop and run assembly illustrated in FIG. 1, wherein components comprised inside the coop are depicted.

FIG. 5 is a sectional view of a side door of the coop illustrated in FIG. 1, wherein a gasketless water ingress system is depicted.

FIG. 6 is a sectional view of the side door illustrated in FIG. 5, illustrating friction locks.

FIG. 7 is a sectional view of the side door illustrated in FIG. 5, further depicting a feeder with a z-clips mounting solution.

FIG. 8 is a sectional view of the nesting box with lid illustrated in FIG. 2, further depicting a nesting box and lid, wherein a gasketless water ingress system is shown.

FIG. 9 is an exemplar embodiment of a user interface for a services orders page on a website related to coops and flocks.

FIG. 10A to 10D are exemplar embodiments of user interfaces for use with a smartphone application or mobile app, wherein the user interfaces are used to order services related to coops and flocks.

### DETAILED DESCRIPTION

While the present subject matter is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

As used herein and in the appended claims, the singular forms “a”, “an”, and “the” include plural referents unless the context clearly dictates otherwise. In other words, use of the articles allow for “at least one” of the subject items in the description above as well as the claims below. The claims may exclude any optional element. As such, this statement is intended to serve as antecedent basis for use of such exclusive terminology as “solely,” “only” and the like in connection with the recitation of claim elements, or use of a “negative” limitation.

The subject matter described herein and in the accompanying figures is done so with sufficient detail and clarity to permit the inclusion of claims, at any time, in means-plus-function format pursuant to 35 U.S.C. Section 112, Part (f). However, a claim is to be interpreted as invoking this means-plus-function format only if the phrase “means for” is explicitly recited in that claim.

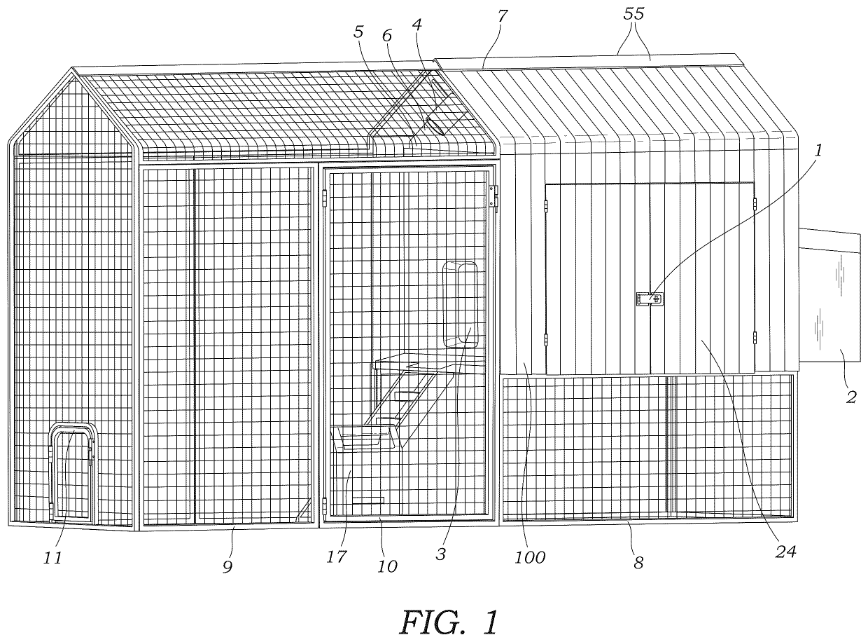

With reference to FIGS. 1-10D, exemplar embodiments of an improved coop system and features related thereto are depicted. More particularly, an improved poultry coop 1 is provided which prevents predators from entering therein, provides significant case in coop maintenance, and enables an individual, such as a poultry keeper, to order outside services, including but not limited to babysitting chickens or coop cleaning.

With particular reference to FIGS. 1-4, a coop 1 is provided which comprises one or more roof panels 55 (best shown in FIGS. 1, 2, and 4). In some embodiments, the roof panels 55 are plastic panels 55. In some embodiments, the plastic panels 55 can be produced by utilizing a roto-molding technology. In some embodiments, the roof panels 55 are double wall panels 55 comprising pins and recesses. Further, the panels 55 allow for fast and easy assembly of the coop 1. For example, a user or poultry keeper can assemble all the panels 55 in a short duration of time, e.g., in ten minutes, without hassle.

The double wall technology of the panels 55 allows for better insulation of coop 1 interior space from excessive heat or extremely cold temperatures. In addition, in severe temperatures, these panels 55 can be filled with foam on demand. For example, in some embodiments, a foam material, such as, polyurethane foam insulation, can be utilized. Those of skill in the art will recognize that other materials can be utilized for the panels 55 without departing from the scope of the disclosure.

According to an aspect of the embodiments, the coop 1 comprises one or more entrances or chicken doors 3 configured as a passageway for one or more chickens or animals of the like, side doors 24 (also herein referred to as a “swing door 24”) configured as a passageway for the one or more animals, and nesting boxes 2, as best shown in FIGS. 1, 2, and 4. According to some embodiments, the chicken doors 3 create a passageway to an interior confines within the run assembly 9, and the side doors 24 create a passageway to a premises external to the run assembly 9 such that the animal can leave the coop system by way of the side doors 24. In some exemplar embodiments, some or all doors 3, 24 and nesting boxes 2 of the coop 1 are lockable. In some embodiments, one or more fasteners can be utilized to lock one or more doors 3, 24 and/or nesting boxes 2. For example, a door 3, 24 and/or nesting box 2 can comprise one or more hasps. Specifically, one or more hasps can be provided on swing door 24 and/or the nesting box 2. In some embodiments, the entrances can be automatic. For example, the coop 1 can include an automatic chicken door 3. In some embodiments, both the chicken door 3 and swing door 24 extend from an exterior side of the coop 1 and are configured to transition between an open and closed configuration. In these regards, the doors 3, 24 of the coop 1 can help ensure living beings, such as animals (e.g., birds, chickens, etc.), are safe during both day and night and at all hours of the day.

Additionally, the coop 1 can comprise automatic, battery-powered door(s) 3, 24, and/or nesting boxes 2 that open at and close at any desired time via a sensor, such as an integrated light sensor based on an amount of light emitting from the external surroundings. For example, the door(s) 3, 24, and/or nesting box(es) 2 can open at sunrise and close at sunset via the integrated light sensor. Further, the battery can be a rechargeable battery that is powered by a small low-power solar panel. In this manner, the solar paneled battery is configured such that it removes the need to replace the battery or connect to the grid where power outlets are not readily available and cannot be moved with the coop across, e.g., a backyard, which is common in backyard farming. The door(s) 3, 24, and/or nesting box 2 can communicate with a remote device via a communication path using a wired or wireless technique so as to allow a user to control the opening and/or closing of the doors 3, 24 and/or nesting boxes 2 through the remote device at a remote location. Example wireless protocols include Bluetooth, Bluetooth Low Energy (BLE, BTLE, Bluetooth SMART, etc.), and others. The remote device can communicate with a local computer system via a communication path using a wired or wireless technique. Local computer system can include one or more of a laptop, desktop, tablet, phablet, smartphone, wearable device (e.g., smart watch), set-top box, or other computing device and wireless communication can include any of a number of applicable wireless networking protocols including Bluetooth, BLE, Wi-Fi or via a communications path with a network, by wired or wireless technique as described previously, and can communicate similar to how the remote device can communicate via a communications path with the network. The network can be any of a number of networks, such as private networks and public networks, local area or wide area networks, and so forth. A trusted computer system can include a server and can provide authentication services and secured data storage and can communicate via communications path with the network by wired or wireless technique.

In some embodiments, the user can control the opening and/or closing of the doors 3, 24, and/or nesting box 2 through a mobile application (also herein referred to as a “mobile app,” “app” or “Coop app”) and/or web portal via the remote device. Specifically, the reader device can comprise one or more processors coupled with a memory, the memory storing the mobile app that is in operable communication with the coop system.

The door(s) 3, 24 and/or nesting box 2 can be configured such that they can be programmed so as to use GPS coordinates for improved tracking of different times of a day, e.g., at sunrise and sunset. In some embodiments, the doors 3, 24 and/or nesting box 2 can communicate with the remote device via a communication path and output an alert or notification to a display via the mobile app. In this manner, the mobile app can inform the user when a detection of the doors 3, 24 and/or nesting box 2 opening and/or closing has occurred, or when the system has detected the animals are outside of the coop 1, indicating to the user that a state of danger has been triggered such that the user can take precautionary or mitigating measures. In some embodiments, the coop 1 further comprises dual, wireless video surveillance cameras with smart predator detection, event recording, mobile notifications, as well as a built-in flashlight and siren alarm to repel predators.

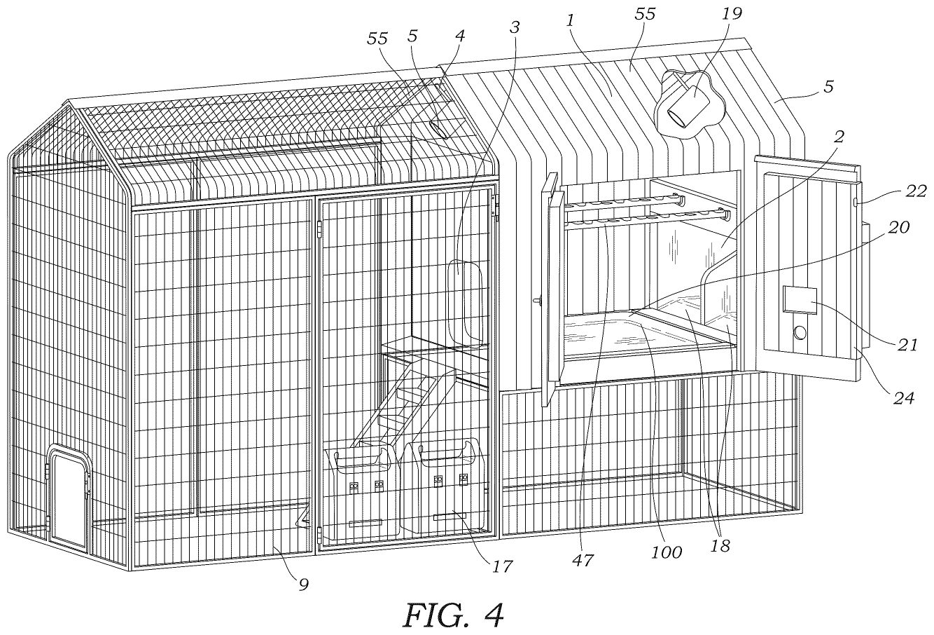

The coop system can further comprise a camera system with one or more cameras configured to surveil different areas of the coop system. According to an aspect of the embodiments, and as best shown in FIGS. 1 and 4, a first camera 4 (e.g., a surveillance camera 4, also herein referred to as a “Runcam” or “outside camera”) can be disposed outside of the coop 1 and can be configured to surveil at least the outside premises of the coop 1 and/or a run assembly 9 attached or adjacent to the coop 1, and wherein the run assembly defines an inner space or confine of the coop system. In some embodiments, the first camera 4 can be attached to an exterior surface of the coop 1. Further, in some embodiments, the first camera 4 can be comprised within the run assembly 9. In some embodiments, and as best shown in FIG. 4, a second camera 19 (e.g., a surveillance camera 19, also herein referred to as a “Roostcam” or “inside camera”) can be comprised within the coop 1 and can be configured to surveil at least the coop and interior space thereof. The camera system can be connected to or communicatively coupled with an application related to or monitoring the coop 1, such as the coop app, which can be in the form of a smartphone application, via any of the wireless networking protocols described herein. In this manner, cameras 4, 19 can transmit data collected therefrom to the mobile app for output to the user via the mobile app.

Specifically, the coop 1 can perform various diagnostics from the collected data related to the coop 1 and/or animals related thereto at a same time. More specifically, in some embodiments, a remote server can utilize AI software to perform and process general diagnostics. For example, general activity or detection of events can be identified using data collected from the still frames captured by the cameras 4, 19 of the coop 1 through a back-end server of the remote server. The data collected via the camera vision and/or frames from the cameras 4, 19 can be configured to offer and/or calculate egg count, indicate when to clean the coop 1 for optimal hygiene by providing the user a visual of the cleanliness of the coop 1, auto-identify breeds to allow users to properly nurture and provide nutrients to the coop 1, and provide discovery of behavioral changes in birds within bigger flocks of fifty or more birds, or animals of the like, and receive and process sounds produced by animals which indicate different states the animals can be in. In some embodiments, the coop app can utilize local AI software to offer and/or calculate egg count, indicate the cleanliness of the coop, auto-identify breeds, and provide discovery of behavioral changes in birds. More specifically, the coop app, based on the general diagnostics performed by the remote service and data collected therethrough, can perform more specific diagnostics, such as, flock-specific detections, chicken count, eggs count, and the individualization of hens' wellness, receive and process sounds produced by animals which indicate different states the animals can be in, and the like. The coop app can also output one or more alerts or notifications to a display, wherein the one or more alerts or notifications comprising information related to the diagnostics from the collected data.

Further, in some embodiments, the mobile app allows users, with one or more taps of the fingers or some other predetermined gesture, to check on the coop 1, its premises, and/or other animals (e.g., birds or other living beings) associated therewith, as will be described in further detail below. In some embodiments, the application can provide diagnostics by utilizing artificial intelligence (“AI”) capabilities, evaluating the environment, and alert users with, e.g., push notifications, about predators or other dangers in sight of either one of the cameras 4, 19 of the camera system. In this regard, the mobile app and improved coop 1 can save animals' lives. Further, both cameras 4, 19 can comprise a programmable siren and/or flashlight that can be utilized as an alarm to scare away potential predators or other posed threats. In this regard, the cameras 4, 19 not only provide peace of mind for the user(s), but also eliminate the need for users to walk towards the coop 1 to check on the flock, as this can be done via the application. In some embodiments, the cameras 4, 19 and/or the mobile app allow the user to identify trend information related to predator visits. Specifically, the one or more processors can process images on a remote service and output, via a notification/alert on the mobile app, to the user information related to predator visit trends. For example, the user can predict, based on the number of visits, the tendency and/or likelihood that a particular number of predators and/or type of predators will appear at a future time period.

Specifically, the cameras 4, 19 or systems related thereto can comprise built-in microphones and processors so as to receive and process sounds produced by animals (e.g., birds, chickens, etc.) for analysis/diagnostics. There are various types of distinguishable sounds produced by animals, such as birds, which indicate different states the animal can be in (e.g., including but not limited to a state of fear, satisfaction, or laying an egg). Because the cameras 4, 19 are communicatively coupled with the coop app, analysis of such sounds and notifications/alerts relating thereto can be transmitted to the coop app installed on the remote device of the user. Further, the cameras 4, 19 can allow the user, through the coop app, to check for new eggs or predators if, e.g., a sound associated with fear is detected. In this manner, the diagnostics provided by the cameras 4, 19 and alerts provided by the coop app to the user increase automation and provide actionable information for the user, such as a poultry keeper, to act upon. The diagnostic information provided to the user by the coop app also allow the user to monitor and review health deterioration for individual animals (e.g., chickens). For example, cameras 4, 19 can also identify individual animals, such as chickens, and detect changes in activity that can suggest potential illness diagnostics.

The mobile app can further be in wireless communication with a third-party reader/remote device, such as a veterinarian's remote/reader device, via communication link. Specifically, communication circuitry can be configured to wirelessly communicate data with the third-party reader/remote device via a Bluetooth, Wi-Fi, or Near Field communication protocol. According to some embodiments, the third-party reader device can be a smart phone, receiver device, or the like. The third-party reader device can be in wireless communication with the trusted computer system through a network, and can include communication circuitry configured to wirelessly communication data with trusted computer system or the mobile app via, e.g., an 801.11x communication protocol or a cellular communication protocol. In this manner, the third party, such as the veterinarian, can review the data transmitted from the mobile app of the user to the third-party reader device and, in response, transmit a payload, via the communications link, comprising guidance relating to a treatment protocol or respective visit recommendations for further investigation.

The mobile app can further allow the user to communicate with other third parties for trading/exchanging within the coop marketplace. Specifically, the mobile app can comprise a local marketplace which allows individuals, such as backyard farmers, to trade produced eggs and/or baby chicks with other third parties, such as, neighbors or other farmers at a remote location. For example, the mobile app, through its diagnostic information, can provide early detection of roosters from new baby chicks, and transmit data to the in-app marketplace so that the individuals can exchange with other third parties who might be interested in roosters.

Further, a personal neural network in the mobile app of a particular user can allow for the personalization of analysis and recommendations related to the performed diagnostics. For example, each diagnostic performed related to the coop 1 and/or animals related thereto can be performing by a neural network running on the user's remote device in the mobile app or through a remote server based neural network. In this manner, the mobile app and diagnostics related to the coop 1 allow for reduced costs of servers running neural networks and allow coop-specific diagnostics to be precise and local to the mobile app.

The doors 3 and cameras 4, 19 described herein can be utilized with any generic coop system available in the market. For example, poultry keepers with a traditional coop, unlike coop 1, can install doors 3 and cameras 4, 19 with AI software program. In this manner, poultry keepers and the like can reap the benefits of predator detection and deterrence, well-being diagnostics, maintenance simplification, health analysis, and new egg alerts, through the utilization of doors 3, and cameras 4, 19 in their system.

In some embodiments, and as best shown in FIGS. 1 and 4, the coop 1 can include one or more windows 5 so as to provide increased light penetration into the coop 1. According to an aspect of the embodiments, one or more outside cameras 4 can be mounted on windows 5. Further, the windows 5 can comprise ventilation holes 6. Specifically, the ventilation holes 6 can be concealed. More specifically, the ventilation holes 6 can be disposed on both a first and second side of the windows 5.

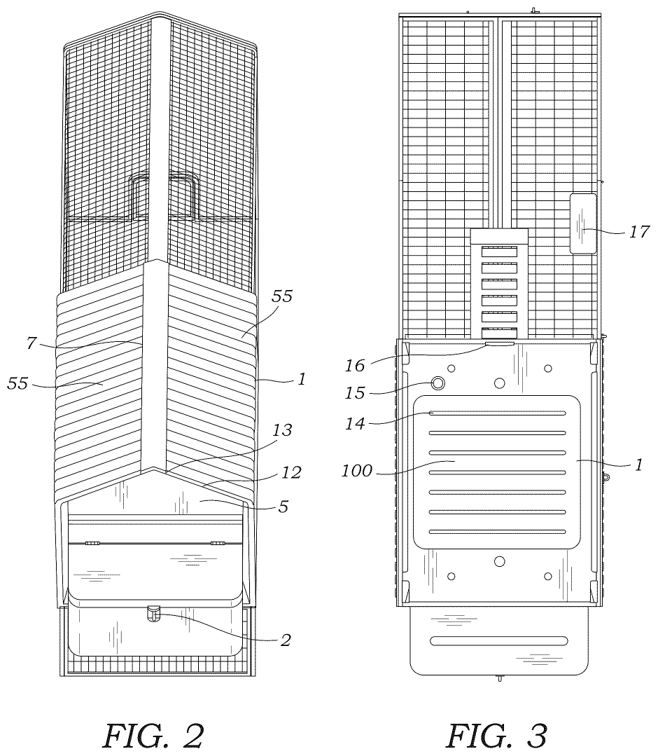

Further, in some embodiments, the coop 1 can also include a roof cap 7 (FIGS. 1 and 2) on a top surface thereof, and bottom slots 14 (FIG. 3) on a bottom surface thereof. In some embodiments, the ventilation holes 6 in conjunction with vent holes under the roof cap 7 and bottom slots 14 create an improved ability to ventilate the inner space of the coop 1. For example, in some embodiments, a minimum temperature difference of 5° Celsius or 9° Fahrenheit has been observed, which can lead to an airflow of 1.87 cubic feet per minute (“CFM) while the chicken door 3 is in the closed configuration, and an airflow of 3.91 CFM while the chicken door 3 is in the open configuration. In some embodiments, such CFM can provide an 8.57 Air Changes Per Hour (“ACH”) while the chicken door 3 is in the closed configuration and a 17.97 ACH while the chicken door 3 is in the open configuration. Those of skill in the art will recognize that other temperature differences, CFM values, and ACH values can be observed without departing from the scope of this disclosure.

According to an aspect of the embodiments, and as best shown in FIGS. 1 and 3, the chicken door 3 can be in the open configuration between sunrise and sunset. Further, the chicken door 3 is configured to operate in several modes. For example, the chicken door 3 can comprise a first mode which utilizes a passive infrared (“PIR”) sensor to assess the amount of light. Further, the PIR sensor can be utilized to transition the chicken door 3 between the open and closed configurations. Additionally, the chicken door 3 can comprise a second mode which allows it to transition between an open and closed configuration at a predetermined hour (e.g., a particular hour, such as 9 P.M.). According to yet another aspect of the embodiments, the chicken door 3 can be automated and can further comprise a third mode which is based on global positioning system (“GPS”) coordinates for said automated chicken door 3. The aforementioned modes can save up to 20 minutes of delay, or any other predetermined period of time for delay that the user sets, for transitioning between the open and closed configurations of the chicken door 3 to ensure all chickens are in the coop 1.

Further, the chicken door 3 can comprise an injury prevention mechanism. Specifically, the chicken door 3 can be configured to stop closing if there is a chicken detected in or around the chicken door 3. More specifically, the chicken door 3 can assess the difficulty associated with closing the chicken door 3, and can open the chicken door 3 if any obstacles are detected or identified. Furthermore, cameras 4, 19 can notify the user of the detected or identified obstacles to all verification that all animals (e.g., chickens) are in the coop 1 and/or if any intervention from a human is required.

According to an aspect of the embodiments, a user can remotely connect to the Roostcam 19 and/or Runcam 4 to ensure that all birds/animals are in the coop 1 and that the chicken doors 3 are closed for the night without the labor of traveling to the coop 1. In this regard, the improved coop 1 provides a more convenient and safe means for the user(s) to manage their animals. For example, over a five-year term, such automation would eliminate a minimum of 40 full regular eight hours working days which would traditionally be required to check on the coop 1 animals, or open and/or close the chicken door 3 as needed.

With particular reference to FIG. 4, the interior of the coop 1 is shown. The interior can comprise one or more roosting bars 47 (e.g., two roosting bars 47, as shown in FIG. 4). In some embodiments, the roosting bars 47 can be composed of extruded plastic and comprise a substantially or entirely rectangular shape 1″×2″ having rounded edges. The roosting bars 47 are shaped so as to prevent injury to the animals roosting thereon. For example, the roosting bars' 47 one or more rounded edges are designed so as to avoid injury or damage to chickens' feet and allow chickens to relax their feet thereon while roosting. Those of skill in the art will appreciate that the roosting bars 47 can be composed of various other materials and comprise various other shapes without departing from the scope of this disclosure.

In some embodiments, the nesting box 2 can comprise one or more nesting sections 18. In some embodiments, nesting box 2 include two nesting sections 18, as shown in FIG. 4. Unlike traditional coops, the nesting sections 18 of the coop 1 are slightly tilted and recessed by a predetermined length (e.g., one inch, two inches, three inches, etc.). The nesting sections 18 can further extend towards the outside of the coop 1 so as to prevent nesting pads from coming out of the nesting sections 18.

Further, and as shown in FIGS. 1 and 4, the coop 1 can comprise a removable coop floor 100. According to an aspect of the embodiments, a molded pulp tray 20 is configured to cover the coop floor 100 (see, e.g., FIG. 4). In this regard, the tray 20 can provide a convenient means to swap bedding for chickens or animals of the like, and allow for improved sanitary conditions. In this manner, the user or poultry keeper no longer bears the burden of cleaning wastes, such as chicken manure, from a flat floor. Further, the poultry keeper is no longer required to provide a deep litter approach which presents difficulties in particular weather conditions. In some embodiments, the tray 20 can be swapped out as desired by a user. For example, a user can swap out a molded pulp tray 20 every week or month.

Specifically, in order to swap out the tray 20, a user must pull an edge of the tray 20, e.g., an edge closest to the user, in an outward direction. Subsequently, the user can grasp a corner of the tray 20, for example, a right or left corner, and fold the tray 20, for example, in half, along a prefabricated line and cut-outs found on the edges of the tray 20. Following this, the folded tray 20 can be placed in a compost pile. The folding of the tray 20 allows the user to keep dirty bedding inside the tray 20 between the coop 1 and compost pile. Additionally, the user can place a new tray 20 on the coop floor 100. According to an aspect of the embodiments, the user can further provide bedding for the tray 20. In this regard, the user saves time associated with keeping a coop 1 sanitary. For example, the swap out procedure of the tray 20, as described above, can be done in less than five minutes, and can be at least ten minutes quicker than other traditional solutions available on the market. In addition, the tray's 20 pulp is an excellent carbon source for plants after it biodegrades on a compost pile. In this regard, the tray 20 serves multiple functions for an improved coop 1 and improved life for organisms associated therewith.

Further, the coop 1 can comprise bottom vent slots 14 which ensure that the tray 20 is in a dry condition. In this regard, and as best shown in FIG. 3, the bottom vent slots 14 are configured so as to not allow ammonia or the like to buildup within the inner space of the coop 1.

In some embodiments, and as best shown in FIG. 3, the floor 100 of the coop 1 comprises vent holes 15. According to an aspect of the embodiments, the vent holes 15 can each be covered with a plug. Additionally, the vent holes 15 can be configured to run an electric cable inside the coop 1, which can be useful during winter times when there is a need to provide an additional source of heat or prevent water from freezing. In some exemplar embodiments, the coop 1 is configured to be partially or entirely autonomous. In some embodiments, the automatic functions of the coop 1 can be battery-powered. Those of skill in the art will appreciate that other powering mechanisms can be utilized for the autonomous functioning of the coop 1 without departing from the scope of the disclosure.

In some exemplar embodiments, and as best shown in FIG. 2, roof panels 55 can comprise one or more rain channels 13. In some embodiments, the roof panels 55 comprises two rain channels 13. The rain channels 13 are configured along the roof cap 7 so as to provide a concealed gutter for rainwater while simultaneously serving as vent channels to generate optimal air exchange numbers, as previously discussed herein.

As best illustrated in FIG. 2, the roof panels 55 can further comprise ribs 12. In some embodiments, the ribs 12 are configured to be relatively small in size so as to produce an invisible or near-invisible effect. In other words, the ribs 12 are configured so as to not be visible to an individual's naked eyes. In some embodiments, the ribs 12 are disposed along each side of the roof panels 55. In this regard, the ribs 12 provide rainwater channels which utilize surface tension properties so as to prevent water from entering the coop 1. Such ribs 12 maintain their functionality, even at inclined angled, such as, for example, when angled at a 15° incline.

According to yet another aspect of the embodiments, and with reference to FIG. 4, side doors 24 (also herein referred to as a “door 24” or “swing door 24”) of the coop 1 comprises a water ingress prevention system. More specifically, the water ingress prevention system can be configured so as to not require a rubber gasket as other solutions available on the market.

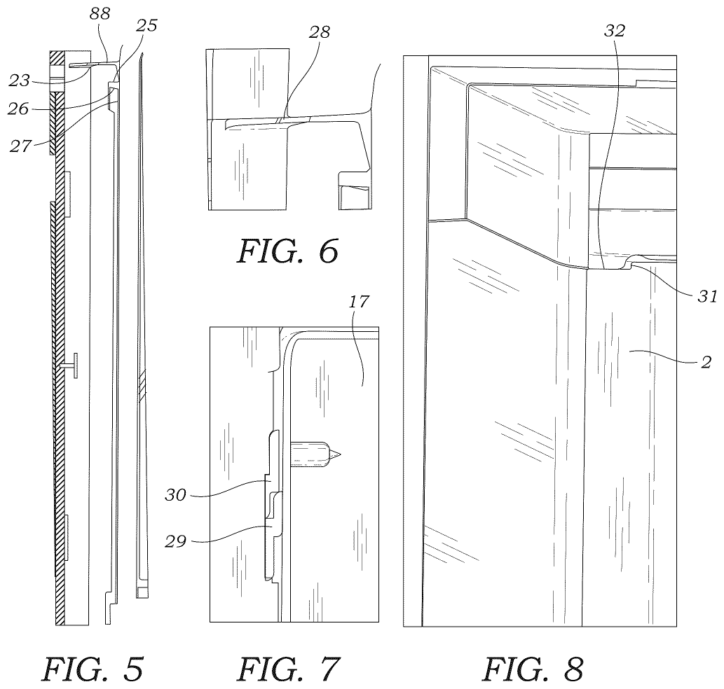

Further, and to provide for an improved coop 1, a portion of the roof panel 55 above the side doors 24 comprises a sharp edge. In some embodiments, and as shown in FIG. 5, the roof panel 55 is angled in an upward direction, and is positioned directly adjacent and proximal relative to the side doors 24. In this manner, the roof panel 55 acts as a stopper for torrents of water that can run from the roof. As depicted in FIG. 5, and to compliment it, the side door 24 comprises an angled surface 88 led in an upward direction from a top surface 23, wherein the angled surface 88 comprises a sharp edge. Further, in some embodiments, the top surface 23 is angled about three millimeters (“mm”) in an outward direction. In this regard, any water drops coming from the roof remain outside and do not accumulate on the top surface 23 of the side door 24. In the instance that water gets between the roof panel 55 and side doors 24 during strong side wings, the water will ride from the angled edge inside the coop 1 and fall off the sharp edge 25 into the horizontal gutter 26 on the wall panel (see, e.g., FIG. 5). This horizontal gutter 26 has an incline from the center to the sides to drain water to the left and right sides. In some embodiments, the incline from the center to the sides is at or about three degrees. On the left and right side where the side door 24 is hinged, another vertical gutter 27 on the wall panel drains water all the way down out of the coop 1 (see, e.g., FIG. 5).

In some embodiments, and as shown in, e.g., FIG. 8, the coop 1 can include the nesting box 2. In particular, FIG. 8 depicts a top portion 31 of the nesting box 2. As depicted, the top portion 31 of the nesting box 2 can include a vertical edge across an entire perimeter of a lead. Further, and still with reference to FIG. 8, the nesting box 2 lid can include a similar downward outdent 32 which, in combination with the top portion 31 of the nesting box 2, creates a water lock.

Further, according to another aspect of the embodiments, the side doors 24 can be configured such that they are able to close with the touch of one hand or some other predetermined gesture. Specifically, and with particular reference to FIG. 4, the top of each side door 24 comprises a hump and the roof panel 55 comprises a small recess. This allows a frictional force to close each side door 24 with just one hand before using a spring latch 22 or hasp to lock the side doors 24. In some embodiments, this frictional mechanism prevents unwanted noise from side doors 24 disturbed by winds. In this regard, unwanted noise does not disturb animals within the coop 1 at nighttime or during sleeping hours.

As best illustrated in FIGS. 1, 3 and 4, the coop 1 and/or run assembly 9 can further comprise feeder(s) 17. Feeders 17 can interchangeably be used for food and water. In some embodiments, the run 9 can further comprise a run human door 10 and/or a run chicken door 11 so as to provide access for birds, for example, during the daytime. Specifically, z-shaped clips 30 (FIG. 7) can be implemented on feeders 17 on run human door 10 or any other place in the run 9. More specifically, z-shaped clips 30 can be implemented on coop doors during night time or to hang on the run 9 wire mesh during day time. Even more specifically, the run human door 10 and/or run chicken door 11 can comprise wire mesh for hanging feeders 17. Bird keepers can have two sets of such feeders 17 to avoid unneeded visits to the coop 1.

In some exemplar embodiments, and with reference to FIG. 1, the coop 1 sits on a metal frame, or base 8. Further, the coop 1 is attached to the run 9. In some exemplar embodiments, the run 9 can be a metal run 9. In some embodiments, run 9 and base 8 constitute a protected outdoor space for chickens or animals of the like. A wire mesh is provided across the base 8 and run 9 and, in some embodiments, comprises a cell size of a half an inch by three inches up to 18 inches from the ground while above cell size is one inch by 3 inches. This cell size prevents even the smallest chickens from being attacked by predators, such as raccoons or the like, if they are too small to coop 1 during the nighttime. This cell size also prevents predators, such as weasels or the like, from entering the coop 1. Further, the run 9, which is protected by the wire mesh from a top portion thereof, provides for better protection of chickens as flying predators are inhibited from attacking said chickens as they fly across the coop 1.

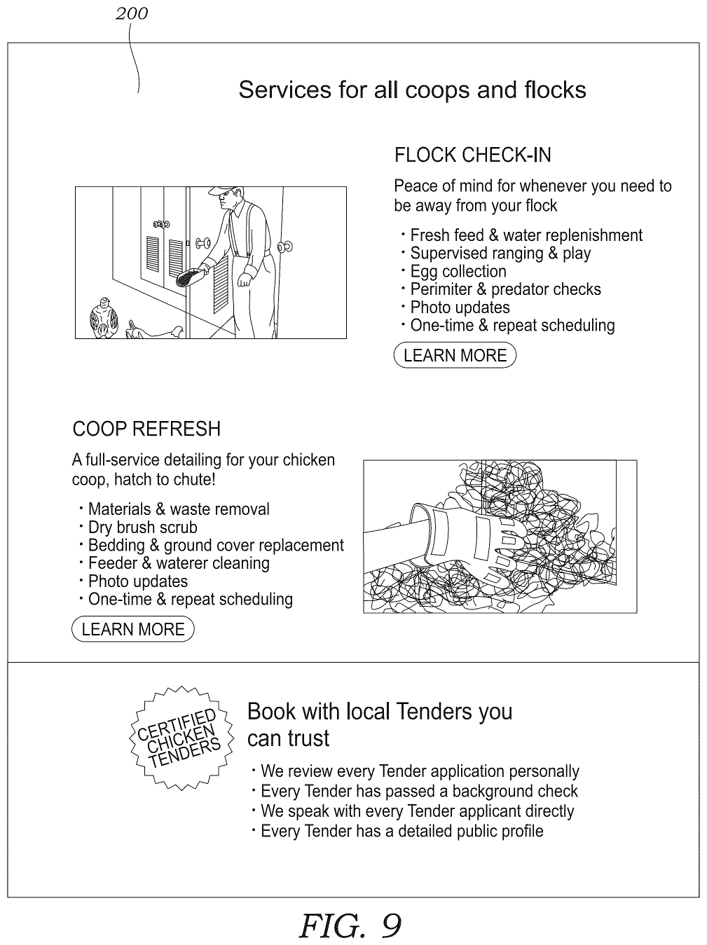

According to another aspect of the embodiments, and with reference to FIG. 9, poultry keepers can connect with other poultry keepers nearby to request and book services by utilizing a user interface 200 relating to a Coop's local services marketplace. In some embodiments, the poultry keepers can request and book at least the following services (also herein referred to collectively as “coop services”) through the user interface 200: (1) Flock Check-In; and (2) Coop Refresh. Coop services are available to any poultry keepers and coops 1. Specifically, coop services are available to any non-industrial poultry keepers and coops 1.

As depicted in FIG. 9, the Flock Check-In service can provide either once or twice/daily visits to a poultry keeper's flock while the poultry keep is away or on leave. In some embodiments, each visit can provide the following: (1) fresh feed & water replenishment; (2) supervised ranging & play; (3) ranging and cooping in the morning and evening (for example, twice/daily only); (4) egg collection; (5) perimeter & predator checks; (6) photo updates; and (7) one-time and/or repeat scheduling. Further, the Coop Refresh service can provide a full-service detailing of a poultry keeper's coop 1, including but not limited to detailing of a hatch and a chute. According to some embodiments, each cleaning or detailing associated with the Coop Refresh service can provide the following: (1) materials and/or waste removal; (2) dry brush scrub; (3) bedding and/or ground cover replacement; (4) feeder and/or waterer cleaning; (5) photo updates; and (6) one-time and/or repeat scheduling.

According to an aspect of the embodiments, the coop services can be locally provided and performed by fellow poultry keepers living nearby who are vetted for their experience with and knowledge of backyard poultry. The poultry keeper providers can be background checked for safety purposes related to the coop services. These providers can be independent contractors working for themselves. The providers can manage their service selection, calendar availability, and service radius to ensure they are only sent requests they want and can complete.

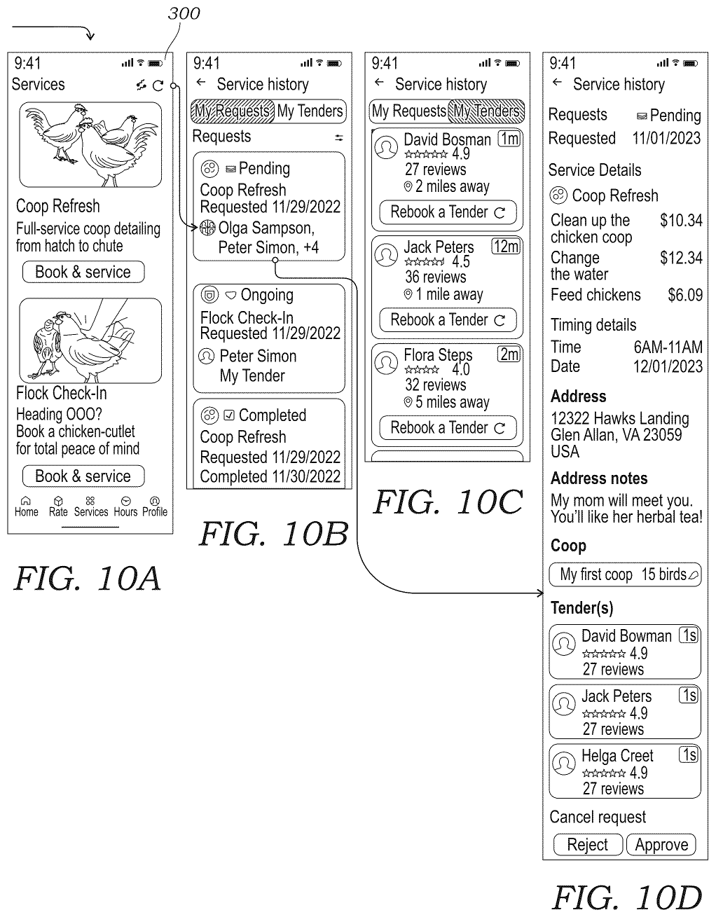

As illustrated in FIGS. 10A-10D, to book a coop service, one can submit a request via a website or mobile app user interface 300. Currently, employees of the Coop's app can disposition and distribute bookings to the service providers nearby. Further, poultry keepers can request services and can communicate with a service provider directly through the mobile app user interface 300. Specifically, poultry keepers will send their requests to their desired service providers. Subsequently, if a service provider is willing to perform the service, the service provider can reply and and/or accept the request through the user interface 300 of the mobile app. Further, if multiple service providers have accepted a particular request, the poultry keeper requesting the service can select which service provider they desire to perform the services.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. These embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the scope of the claims by features, functions, steps, or elements that are not within that scope.

1. A coop system, comprising:
a coop comprising a run assembly, wherein the run assembly defines an inner space of the coop system;
a chicken door configured as a first passageway for one or more animals, wherein the chicken door is configured to transition between an opened configuration and a closed configuration in an automatic fashion;
a camera system comprising first camera configured to surveil the inner space and a second camera configured to surveil an interior of the coop;
a remote device, comprising:
one or more processors coupled with a memory, the memory storing a coop application that, when executed by the one or more processors, causes the one or more processors to:
control the transitioning of the chicken door between the opened configuration and the closed configuration,
wherein the coop application is communicatively coupled with the camera system, and wherein the first camera and the second camera are configured to collect data and transmit the data to the coop application, and
wherein the coop application is configured to output to a display one or more notifications comprising information related to at least one or more of the chicken door and the camera system, the one or more notifications further comprising information related to diagnostics of the coop system.

2. The coop system of claim 1, wherein the coop further comprises one or more roof panels, wherein the one or more roof panels are one or more double wall panels configured to insulate the interior of the coop.

3. The coop system of claim 1, wherein the chicken door comprises a light sensor configured to cause the chicken door to transition between the opened configuration and the closed configuration based on an amount of light emitting from an external surrounding.

4. The coop system of claim 3, wherein the chicken door is further configured to open at sunrise and close at sunset via the light sensor.

5. The coop system of claim 1, further comprising a side door configured as a second passageway for the one or more animals, wherein the side door forms a passageway to a premises external to the run assembly.

6. The coop system of claim 5, wherein the one or more animals are one or more chickens.

7. The coop system of claim 1, further comprising a nesting box with one or more nesting sections having one or more nesting pads, wherein the one or more nesting sections extend towards an outside area of the coop.

8. The coop system of claim 1, wherein the run assembly is positioned adjacent to the coop.

9. The coop system of claim 1, wherein the chicken door is further configured to communicate with the remove device via a communication path using a wireless protocol which includes a Bluetooth communications protocol, a Bluetooth Low Energy communications protocol, or a Wi-Fi communications protocol.

10. The coop system of claim 1, wherein the coop application is configured to inform the user when a detection of the chicken door opening and/or closing has occurred or when the coop system has detected an animal is outside of the coop.

11. The coop system of claim 1, wherein the data collected from the first camera and the second camera is utilized to provide an egg count and information related to a state of cleanliness of the coop, wherein a local artificial intelligence software installed on the remote device is configured to provide the egg count and information provided related to the state of cleanliness of the coop.

12. The coop system of claim 1, wherein the first camera and the second camera each comprise a built-in microphone and a camera processor configured to receive and process sounds produced by animals which indicate different states the animals can be in, wherein an artificial intelligence software installed on a remote server is configured to receive and process the sounds produced by the animals.

13. The coop system of claim 12, wherein the different states the animals can be in include a state of fear, a state of satisfaction, and a state of laying an egg.

14. The coop system of claim 1, wherein the coop application is in wireless communication with a third-party remote device via a communication link and is configured to transmit data collected and processed using artificial intelligence software installed on the remote device to the third-party remote device.

15. The coop system of claim 14, wherein the third-party remote device includes a veterinarian's remote device, and wherein a third party can review the transmitted data and transmit a payload, via the communication link, comprising guidance recommendations relating to a treatment protocol.

16. The coop system of claim 1, wherein the chicken door comprises a first mode of operation and a second mode of operation, wherein the first mode of operation is configured to utilize a passive infrared sensor configured to assess an amount of light and transition the door between the opened configuration and the closed configuration.

17. The coop system of claim 16, wherein the second mode of operation is configured to allow the chicken door to transition between the opened configuration and the closed configuration at a predetermined hour.

18. The coop system of claim 1, wherein the interior of the coop comprises one or more roosting bars, wherein the one or more roosting bars each have one or more rounded edges configured to avoid injury or damage to animals.

19. The coop system of claim 1, wherein the coop comprises a coop floor with a molded pulp tray, wherein the molded pulp tray is configured to cover the coop floor and is removable.

20. The coop system of claim 1, wherein the coop application is further configured to output or more notifications further comprising information related to diagnostics by utilizing artificial intelligence and evaluating the environment through the camera systems.
